(19) United States
(12) Patent Application Publication
(10) Pub. No.: US 2005/0183261 A1
(43) Pub. Date: Aug. 25, 2005

(54) Method of securing a membrane to a deck

(75) Inventors: Edward Nebesnak, Mine Hill, NJ (US); William P. Kuhn, Stonington, CT (US)

Correspondence Address: Attn: William J. Davis, Esq.;GAF MATERIALS CORPORATION, Legal Dept, Bldg. 8, 1361 Alps Road, Wayne, NJ, 07470, US

(73) Assignee: BUILDING MATERIALS INVESTMENT CORPORATION

(21) Appl. No.: 11/108,411

(22) Filed: Apr. 18, 2005

Related U.S. Application Data
(63) Continuation-in-part of application No. 10/378,103, filed on Feb. 27, 2003.
(62) Division of application No. 10/310,744, filed on Dec. 5, 2002.

(51) Int. Cl. F16B 23/00

(52) U.S. Cl. 29/525.01; 411/396

(57) ABSTRACT

The present invention is a method of securing a first thermoplastic membrane to a second thermoplastic membrane and securing these membranes to an underlying deck. The steps of the method comprise providing a composite fastener, placing the first thermoplastic membrane on the deck, placing the composite fastener on a marginal portion of the first thermoplastic membrane, driving the composite fastener through the first thermoplastic membrane into the deck to fasten it, placing the second thermoplastic membrane to overlap the composite fastener and the marginal portion of the first thermoplastic membrane, and lastly welding the membranes to the composite fastener and each other in a substantially continuous seam.

### CROSS REFERENCE TO RELATED APPLICATIONS

The present application is a continuation in part of and claims the benefit of prior U.S. application Ser. No. 10/378,103, filed Feb. 27, 2003, and is related to U.S. application Ser. No. 10/310,744 which is a divisional application of U.S. Pat. No. 6,536,498, the disclosures of which are hereby incorporated by reference in their entirety.

### FIELD OF THE INVENTION

The present invention relates to fasteners and a method employed to fasten a covering material to an underlying substrate. More particularly, the invention relates to a method of securing a first thermoplastic membrane to a second thermoplastic membrane and securing said first and said second thermoplastic membranes to an underlying deck

### BACKGROUND OF THE INVENTION

Fasteners are conventionally employed in the building industry for fastening or clamping a flexible membrane, such as a roofing membrane to a substrate, such as a roof deck. The fasteners typically comprise a large head portion and a shank portion. In use, the shank portion is driven through the membrane into the underlying substrate to anchor the fastener, while the head portion holds the membrane against the substrate to prevent uplift of the membrane. The undersurface of the head portion is typically provided with gripping means so that the membrane is prevented from moving or sliding under the fastener. The gripping means do not penetrate completely through the membrane in order to prevent atmospheric moisture from entering into the substrate through the holes that are made by the gripping means. It is also important that the gripping means are spread or distributed in the undersurface of the head portion of the stress plate in order prevent tearing of the membrane.

Under windy conditions the prior art fasteners need improvement in securely holding a flexible membrane on a substrate without the gripping means penetrating the flexible membrane, and without tearing the flexible membrane.

Flexible membrane material manufactured in sheets is designed to be laid down on a substrate such as a roof deck in a slightly overlapping manner or in an abutting relationship and welded together to form a watertight seal. If the overlapping method is used, typically, one to three inches of the overlapped sheets are welded together. The welding is accomplished by subjecting the overlapped portions to heat, softening them to a weldable consistency and pressing them together manually or by pressure rollers of an apparatus. When the overlapped portions of the sheets cool, a solid, watertight seal is formed at the seam of the welding. When the sheets are laid down with their edges being in an abutting relationship, the sheets are welded together by the use of a strip or tape of thermoplastic material laid along the butt which tape fuses to both sheets, and when pressed manually, or by pressure wheels of an apparatus, forms a watertight seal upon cooling.

When an apparatus is used to accomplish the weld, it is generally motor driven, self-propelled and automatic in which a drive motor is connected through a drive train to one or more drive wheels. A heating means, such as a hot-air blower, and a sheet-handling means are provided on the apparatus for guiding at least one of the opposing sheets through the apparatus and past the heating means as the apparatus travels along the edge of one of the sheets. The edges of the opposing sheets are heated and laid or placed together while hot. The hot sheets are then subjected to pressure rollers or wheels and are allowed to cool.

In laying these sheets or membranes in overlapping relationship to each other, it is preferable to use a fastening means to firmly hold the sheets on the deck or substrate. For example, in a typical roofing process that takes place at the job site, a first thermoplastic sheet, obtained in a roll form from a supplier, is laid on a portion of the deck starting from one side of the roof. Then a fastening means, such as a batten bar or a line of stress plates is placed close and parallel to the edge of the sheet. The batten bar or line of stress plates on top of the sheet is secured to the underlying deck by securing means, such as screws or nails. After this step in the process a second thermoplastic sheet is laid on the roof deck parallel to the first thermoplastic sheet and in an overhanging relationship therewith wherein the overlapping portion covers the fastening means on both sides thereof. A weld is then applied between the overlapped portion of the first sheet and the overlapping portion of the second sheet on one side of the fastening means and then another weld is applied between the overlapping portions of the sheets on the other side of the fastening means.

It has been observed that stress plates having a high profile create bumps in the weld area. It has also been observed that stress plates made of metals do not adhere to the second or overlapping thermoplastic sheet thereby creating bubbles in the weld. Further, typical pressure rollers are incapable of apply pressure across the stress plates and on either side of the stress plates in one motion.

### SUMMARY OF THE INVENTION

The present invention is a method of securing a first thermoplastic membrane to a second thermoplastic membrane and securing said first and second thermoplastic membranes to an underlying deck. The method comprises providing a fastener comprising a stress plate defined by a top surface and a bottom surface having an opening for receiving a fastener therethrough, a thermoplastic coating covering the top surface of said metal stress plate, and a fastener positioned in said opening of said metal stress plate. The first thermoplastic membrane is placed on the deck and the fastener is placed on a marginal portion of the first membrane. The fastener is driven through the first membrane into the roof deck to fasten the thermoplastic roof membrane to the roof deck. Next, the second thermoplastic membrane is placed to overlap the stress plate and the marginal portion of the first membrane. Lastly, the second membrane is welded to the stress plate and the first thermoplastic roof membrane forming a substantially unitary seam from near the edge of the second thermoplastic membrane across the composite fastener to near the edge of the first thermoplastic membrane.

The welding is accomplished with a welding apparatus that comprises a carriage, a heating assembly carried by the carriage, and a seaming assembly also carried by the carriage. Such an apparatus is disclosed U.S. Pat. No. 4,834,828, which is incorporated herein by reference. The seaming assembly of the present invention directs heat generated by the heating assembly and also applies pressure to the membranes forming a substantially continuous width seam across the width of a weld wheel or pressure roller wide enough to create a substantially unitary seam on either side and over the fastener. The pressure roller is preferably covered with an elastomer cushion.

### BRIEF DESCRIPTION OF THE DRAWINGS

FIG. 1 is a front view of an embodiment of the pressure roller of the present invention.

FIG. 2 is a plan view of fasteners adjacent to the edge of a thermoplastic sheet.

FIG. 3 is a schematic view of a portion of the welding apparatus joining two thermoplastic sheets.

FIG. 4 is a schematic view of two thermoplastic sheets welded together with a unitary seam.

FIG. 5 is a perspective view of one embodiment of a composite fastener.

FIG. 6 is a cross-sectional view of the composite fastener and thermoplastic sheets.

### DETAILED DESCRIPTION OF THE INVENTION

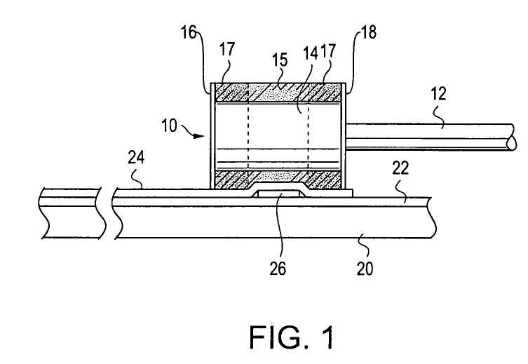

FIG. 1 shows the front view of an embodiment of the pressure roller 10 integral with an axle 12 designed to be connected to a driving means (not shown) at one end thereof. At the other end of the axle there is the pressure roller 10 having a distal end 16 and proximal end 18. The pressure roller 10 carries one or more elastomeric cushions such as a rubber cushion designed to ride over a line of the fasteners of the present invention. In the embodiment of FIG. 1, the pressure roller 10 is carrying a first elastomeric center cushion 15 designed to ride smoothly over the composite fastener and between the fasteners, and two elastomeric side cushions 17 designed to ride over the remaining portions of the membranes. The preferred hardness of the center cushion in this embodiment is mostly determined by the height of the composite fasteners and the weight of the welding apparatus. The higher the fasteners, the softer the cushion should be, while the more weight applied to the pressure roller by the welding apparatus the harder the cushion should be.

FIG. 1 also shows deck 20 covering a roof structure that is to be covered by thermoplastic sheets 22 and 24. First thermoplastic sheet 22 is the bottom sheet fastened to deck 20 by the composite fastener 26 close to and parallel with the selvedge edge of the first thermoplastic sheet 22. The second, or overlapping thermoplastic sheet 24 is laid over first thermoplastic sheet 22 on both sides of the composite fastener 26.

In the present invention, the pressure roller is of a minimum width that can create a single, substantially unitary seam from near or substantially the edge of the second thermoplastic membrane across the composite fastener to near or substantially the edge of the first thermoplastic membrane. This can be accomplished with many different configurations including single wheel and multiple wheel designs and those demonstrated in U.S. Pat. Nos. 6,610,159, 6,536,498, and 5,935,357 which are incorporated by reference.

In a preferred embodiment, a 5.5″ pressure roller having an elastomer cushion around its circumference and a heating element with a 5.25″ nozzle opening is used. This embodiment is able to produce a continuous 5″ weld across substantially the entire width of the pressure roller. The seaming assembly can take any known form that welds a substantially unitary seam from one side of the fastener at substantially the edge of the second thermoplastic sheet to the other side of the fastener including welding the second thermoplastic sheet to the composite fastener. These apparatus are known and include those shown in the patents incorporated herein.

The nozzle is configured to ride over the line of fasteners. The center portion of the nozzle is preferably evaluation elevated to a height enabling it to travel over the fasteners without obstruction but remaining close enough to the membranes and fasteners to provide sufficient heat for welding. Known designs include those found in U.S. Pat. Nos. 6,610,159 and 6,536,498.

The thickness of elastomer cushion is influenced by the dimensions of the fastening means used, especially its height rising above the horizontal plane of the first thermoplastic sheet: the larger the height of the composite fastener the more thickness and resiliency is required in the cushioning material so that it rides over the fastener in a smooth fashion while at the same time air pockets or bubbles are prevented by the force exerted on the overlapping second thermoplastic sheet by the cushion.

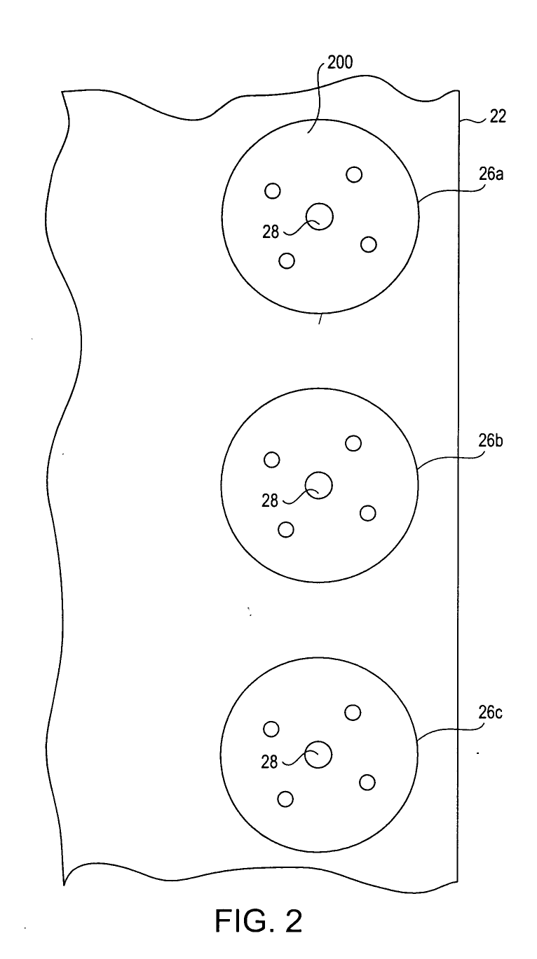

FIG. 2 shows the first thermoplastic sheet 22 on top of which, close to and parallel with the edge thereof, are placed composite fasteners 26a, 26b and 26c. The composite fasteners are stress plates 200 secured to the deck of the roof along with the first thermoplastic sheet 22, with nails, screws or bolts through openings or holes 28.

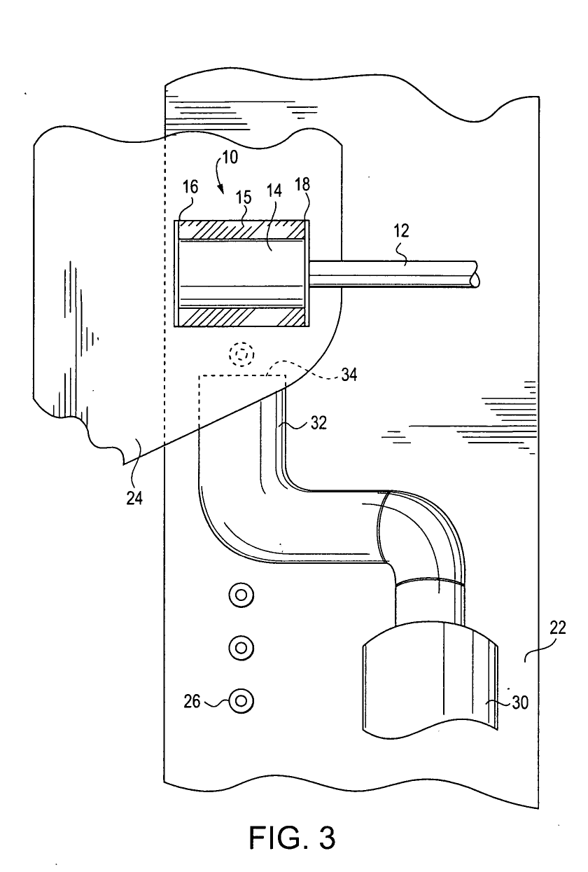

FIG. 3 shows the pressure roller 10 and heating element 30 having opening 34 of nozzle 32 pointed between first thermoplastic sheet 22 and second thermoplastic sheet 24. Nozzle 32 is positioned close to pressure roller 10 both of which are mounted on the chassis of an apparatus (not shown) that is propelled along the overlapping portions of the thermoplastic sheets. As the apparatus travels over the composite fastener 26, and on both sides thereof, the heated air generated by the heating element softens the upper face of the first thermoplastic sheet and the lower face of the second thermoplastic sheet to plasticity. Pressure roller 10 having distal end 16 and proximal end 18 travels on both sides of composite fastener 26 exerting sufficient pressure onto the overlapped portion of the overlapping thermoplastic sheets to produce a weld. This weld includes the top surface of the composite fastener 26.

In the preferred embodiment shown in FIG. 3, portions of a rubber cushion around the pressure roller 15 roll directly over the composite fastener 26 compressing the sheet material, while portions of the rubber cushion 15 adjacent to the composite fastener 26 conform to the underlying second thermoplastic sheet and expel air from between the overlapping portions of the thermoplastic sheets so as not to allow formation of air pockets or bubbles. The heating element 30 also contains a blower (not shown) which forces heated air through the nozzle 32 onto the overlapping portion of the thermoplastic sheets.

The opening 34 of the nozzle 32 is preferably designed to direct hot air onto both sides of the composite fastener 26 where the overlapping portions of the thermoplastic sheets will be welded together as a result of heating and compressing them by the pressure roller 10. Also, outflow of heated air from the nozzle 32 must be sufficient to soften the overlapping portion of the thermoplastic sheets over and under the composite fastener in order to weld the thermoplastic sheets together over the interposed composite fastener and weld the fastener 26 to the second sheet. Many known nozzle designs can accomplish this including those in U.S. Pat. Nos. 6,610,159, and 6,536,498, which are incorporated.

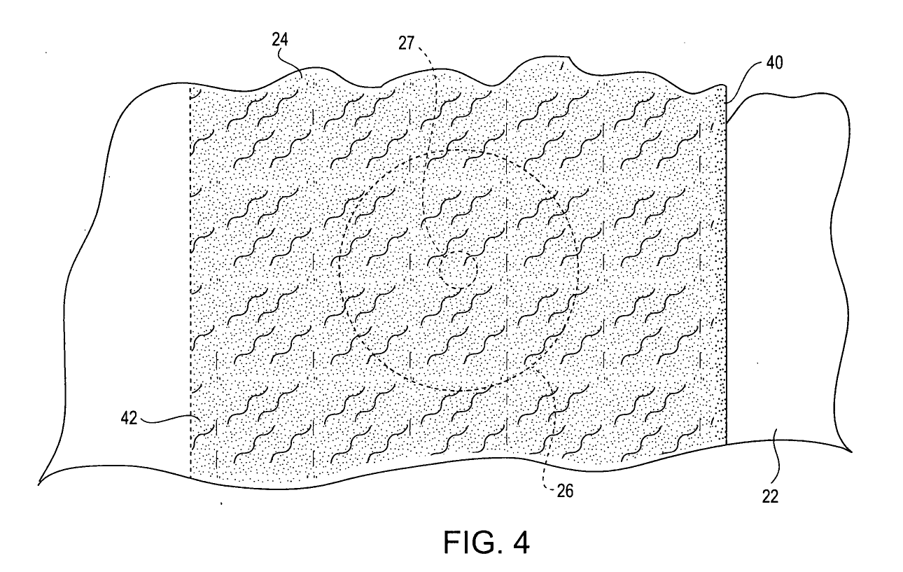

FIG. 4 shows two thermoplastic sheets welded together. The first thermoplastic sheet 22, is secured by a single composite fastener 26 with a screw 27 to secure the first thermoplastic sheet 22 onto the underlying deck. Seam 40 is the edge of second thermoplastic sheet 24 while invisible seam 42 is the edge of the first thermoplastic sheet 22.

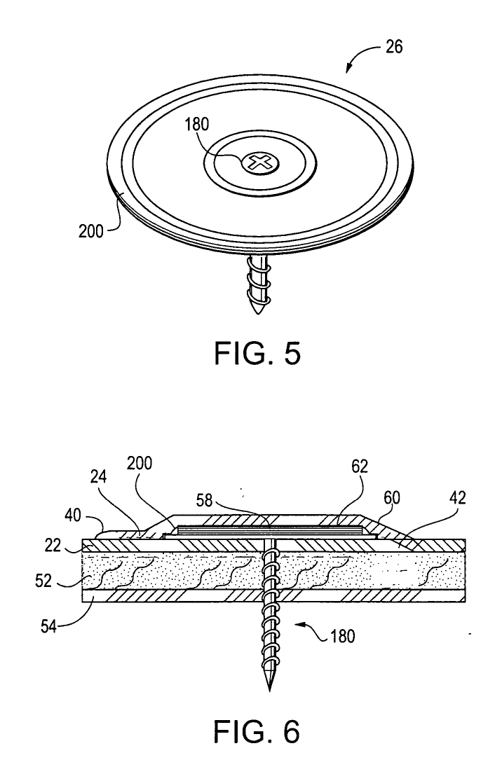

FIG. 5 relates to a first embodiment of the composite fastener 26 in which the stress plate is generally designated 200 and the fastener is generally designated 180. The components may or may not be integral to each other. The stress plate 200 has an opening through which the fastener 180 is inserted when the stress plate 200 is employed for attaching and firmly holding a sheet to an underlying deck. The fastener can be of any known type including screws or nails. The stress plate 200 has a top surface and a bottom surface and can be of any preferred shape. The opening can also be of any shape adapted to receive the fastener.

The composite fastener 26 preferably comprises a metal stress plate, a thermoplastic coating covering the top surface of the metal stress plate, and a fastener positioned in the metal stress plate. The fastener is formed preferably of stainless steel, galvalume or galvanized metals, can be a nail, screw or other known design, and is preferably 2 to 3 inches long. The fastener preferably has a low height profile, most preferably in the range of about 0.030″ to about 0.350″. Softer metals such as copper and aluminum may also be used, however, the thickness of the stress plate should be larger to provide sufficient integrity to the stress plate.

Preferably, the thermoplastic coating of the stress plate is a material selected from a group consisting of polyvinyl chloride, thermoplastic olefins, chlorinated polyethylene, chlorosulfonated polyethylene, nylon and ethylene propylene diene rubber. Preferably, the thermoplastic coat substantially covers the top surface of the stress plate, however it is contemplated the coating may cover only a portion of the top surface. The thermoplastic coating is adapted to melt from the heat provided from the seaming assembly. Once melted the pressure roller forces the melted coating into contact with the underside of the second thermoplastic membrane. When the coating cools a weld is created between the stress plate and bottom of the second thermoplastic membrane.

The method of securing the first thermoplastic membrane to the second thermoplastic membrane and securing the membranes to an underlying deck comprises placing the composite fastener on a marginal portion of the first thermoplastic membrane and driving it through the first membrane into the roof deck. The second thermoplastic membrane is placed to overlap the composite fastener and the marginal portion of the first membrane. Next, the second membrane is heat sealed or welded to the composite fastener and the first membrane forming a substantially unitary seam from substantially an edge of the second membrane across the composite fastener to substantially the edge of the first membrane. The weld is formed on top of the composite fastener since the stress plate has a thermoplastic coating on its top surface that melts when exposed to the heat of the welding apparatus and cools after being comprised onto the second membrane.

In a preferred embodiment, this invention can be practiced in conjunction with the fasteners described in U.S. patent application Ser. No. 10/357,113, filed Feb. 3, 2003, the disclosure of which is hereby incorporated by reference in its entirety. Such fasteners feature multiple pairs of barbs extending downward from the bottom surface of the fastener plate and provide further resistance to wind uplift.

FIG. 6 is a cross-sectional view illustrating the use of the composite fastener 26 for attaching a roof membrane to a roof deck. First thermoplastic membrane 22 is positioned over insulation 52 that is over the roof deck surface 54. The fastener 180 is then inserted through stress plate 200, insulation 52, and into roof deck 54. Second thermoplastic membrane 24 is then placed over the marginal portions of the lower membrane covering the stress plate 200. The second thermoplastic membrane 24 is secured to the stress plate 200 and the first membrane 22 by welded seam 62. Each membrane has an edge at the end of the marginal portions, this edge is preferably a selvedge edge. Common membranes include bottom and top polyolefin based sheets with a reinforcement scrim. Other materials used for these membranes include but are not limited to thermoplastic olefins, polyvinyl chloride (PVC), chlorinated polyethylene (CPE), ethylene propylene diene terpolymer (EPDM), atactic polypropylene (APP) modified bitumen, and styrene butadiene styrene (SBS) modified bitumen.

Accordingly, it should be readily appreciated that the method of the present invention has many practical applications. Additionally, although the preferred embodiments have been illustrated and described, it will be obvious to those skilled in the art that various modifications can be made without departing from the spirit and scope of this invention. Such modifications are to be considered as included in the following claims.

1. A method of securing a first thermoplastic membrane to a second thermoplastic membrane and securing said first and said second thermoplastic membranes to an underlying deck comprising the steps of:
providing a composite fastener comprising a stress plate defined by a top surface and a bottom surface having an opening for receiving a fastener therethrough, a thermoplastic coating on the top surface of the stress plate, and a fastener positioned in said opening of the stress plate;
placing said first thermoplastic membrane on said deck;
placing said composite fastener on a marginal portion of said first thermoplastic membrane;
driving said composite fastener through said first thermoplastic membrane into said deck to fasten the thermoplastic membrane to the deck;
placing said second thermoplastic membrane to overlap said composite fastener and said marginal portion of said first thermoplastic membrane; and
welding the second thermoplastic membrane to the composite fastener and the first thermoplastic membrane forming a substantially unitary seam from substantially an edge of the second thermoplastic membrane across the composite fastener to substantially an edge of the first thermoplastic membrane.

2. A method as in claim 1 wherein:
the composite fastener comprises a metal stress plate.

3. A method as in claim 1 wherein:
the stress plate is of circular configuration.

4. A method as in claim 1 wherein:
the stress plate is substantially ellipsoidal.

5. The method as in claim 1 wherein:
the thermoplastic coating is a material selected from a group consisting of polyvinyl chloride, thermoplastic olefins, chlorinated polyethylene, chlorosulfonated polyethylene, nylon and ethylene propylene diene rubber.

6. The method of claim 1 wherein:
the fastener is a screw member having threads.

7. The method of claim 1 wherein:
the fastener is formed of stainless steel, galvalume or galvanized metals.

8. The method of claim I wherein:
the fastener has a height profile of from about 0.030″ to about 0.350″.

9. The method of claim 1 wherein:
the deck is a roof deck.

10. The method of claim 1 wherein:
the thermoplastic membrane is a roofing membrane.

11. The method of claim 10 wherein:
the roof membrane is a membrane selected from the group consisting of polyvinyl chloride, chlorinated polyethylene, ethylene propylene diene terpolymer, atactic polypropylene modified bitumen, and styrene butadiene styrene modified bitumen.
